(19) United States
(12) Patent Application Publication
(10) Pub. No.: US 2016/0165077 A1
(43) Pub. Date: Jun. 9, 2016

(54) INFORMATION PROCESSING APPARATUS, MANAGEMENT APPARATUS, METHOD OF CONTROLLING INFORMATION PROCESSING APPARATUS, METHOD OF CONTROLLING MANAGEMENT APPARATUS, AND STORAGE MEDIUM

(71) Applicant: CANON KABUSHIKI KAISHA, Tokyo (JP)

(72) Inventor: Daisuke Shibata, Toride-shi (JP)

(21) Appl. No.: 14/954,778

(22) Filed: Nov. 30, 2015

(30) Foreign Application Priority Data
Dec. 3, 2014 (JP) 2014-244868

(51) Int. Cl. H04N 1/00; G06F 3/12; H04N 1/44

(52) U.S. Cl. CPC H04N 1/00344; H04N 1/4413; H04N 1/0032; H04N 1/00639; G06F 3/1222; G06F 3/1205; G06F 3/1204; G06F 3/1238; G06F 3/1288; G06F 3/1267; H04N 2201/0094

(57) ABSTRACT

An information processing apparatus configured to execute job processing includes a communication unit configured to communicate with a management apparatus for managing the information processing apparatus, a management unit configured to register authenticated user information and setting information of the authenticated user in a storage unit, and manage the user information and the setting information, a request unit configured to request a holding unit managed by the management apparatus, to register the user information and the setting information managed by the management unit, by using the communication unit, an acquisition unit configured to acquire from the management apparatus, update information indicating an updated content of a user list for which the management apparatus manages the setting information, and a control unit configured to synchronize the user information registered in the storage unit with the managed user information, based on an update time point in the acquired update information.

### BACKGROUND

1. Technical Field

The embodiments below relates to an information processing apparatus, a management apparatus, a method of controlling the information processing apparatus, a method of controlling the management apparatus, and a storage medium.

2. Description of the Related Art

Information processing apparatuses, such as an image forming apparatus, have a function of reading a user dedicated setting in response to user login and making the user dedicated setting. For example, items in the user dedicated setting include a device setting value for setting a display and an environment, calling a setting of a copy or a facsimile (FAX) function in a simple manner, an address book registering FAX destinations, and the like. The items are recorded in the apparatus when the logging-in user changes the setting. Thus, the next time the user logs in, the same setting is read, so that the apparatus can be used under the same setting.

A technique is available in which a plurality of image forming apparatuses and a user data management server connected to the apparatuses through a network cooperate to synchronize the user dedicated setting among the apparatuses. In the system, when a user logs in to one of the image forming apparatuses and makes a setting, the user data management server is notified of the content of the setting, and the other image forming apparatuses acquire the same setting. Thus, the user can use any of the image forming apparatuses under the user dedicated setting.

The user dedicated setting may need to be deleted in some cases where, for example, the user stops using an image forming apparatus in an environment employing the user dedicated setting. Japanese Patent Application Laid-Open No. 2010-135910 discusses a technique of deleting the user dedicated setting. More specifically, an external apparatus is connected to an image forming apparatus designating a user and a setting, and the corresponding user dedicated setting is deleted. Japanese Patent Application Laid-Open No. 2012-123573 discusses a technique of synchronizing user information between multi-function peripherals (MFPs), and further discusses a technique of managing the information related to the user information that is not a synchronization target.

### SUMMARY

An information processing apparatus according to an aspect of the present invention configured to execute job processing includes a communication unit configured to communicate with a management apparatus for managing the information processing apparatus, a management unit configured to register authenticated user information and setting information of the authenticated user in a storage unit, and manage the user information and the setting information of the user, a request unit configured to request a holding unit managed by the management apparatus, to register the user information and the setting information of the user managed by the management unit, by using the communication unit, an acquisition unit configured to acquire from the management apparatus, update information indicating an updated content of a user list for which the management apparatus manages the setting information, and a control unit configured to synchronize the user information registered in the storage unit with the user information managed by the management apparatus, based on an update time point in the acquired update information.

A management apparatus according to another aspect of the present invention configured to communicate with a plurality of information processing apparatuses for execute job processing includes a management unit configured to register user information acquired from each of the information processing apparatuses and setting information of a user associated with the user information, in a holding unit, and manage the user information and the setting information of the user, a first update unit configured to update a list of the registered user, based on the user information acquired from each of the information processing apparatuses, a second update unit configured to update setting information of a user associated with the list of the registered user, based on the user information acquired from each of the information processing apparatuses, a first response unit configured to transmit update information about the list of the user that has been updated in response to a request to update the user information from each of the information processing apparatuses, to the information processing apparatus as a source of the update request, and a second response unit configured to transmit update information of updated setting information of a user in response to a request to update the setting information of the user from each of the information processing apparatuses, to the information processing apparatus as a source of the update request.

Further features of the present invention will become apparent from the following description of exemplary embodiments with reference to the attached drawings.

### BRIEF DESCRIPTION OF THE DRAWINGS

FIG. 1 is a system configuration diagram illustrating a configuration of an information processing system.

FIG. 2 is a block diagram illustrating configurations of an information processing apparatus and a server apparatus.

FIG. 3 is a diagram illustrating an example of a software configuration of the information processing system.

FIG. 4 is a block diagram illustrating a configuration of data managed by the server apparatus.

FIG. 5 is a flowchart illustrating a method of controlling the information processing apparatus.

FIG. 6 is a flowchart illustrating a method of controlling the server apparatus.

FIG. 7 is a flowchart illustrating a method of controlling the information processing apparatus

FIG. 8 is a flowchart illustrating a method of controlling the server apparatus.

FIG. 9 is a flowchart illustrating a method of controlling the information processing apparatus.

FIG. 10 is a flowchart illustrating a method of controlling the server apparatus.

FIG. 11 is a flowchart illustrating a method of controlling the server apparatus.

FIG. 12 is a flowchart illustrating a method of controlling the information processing apparatus.

FIG. 13 is a flowchart illustrating a method of controlling the information processing apparatus.

FIG. 14 is a flowchart illustrating a method of controlling the server apparatus.

FIG. 15A is a diagram illustrating an example of a user data database (DB) and a user list DB.

FIG. 15B is a diagram illustrating an example of the user data DB and the user list DB.

FIG. 15C is a diagram illustrating an example of a user data database (DB) and a user list DB.

FIG. 15D is a diagram illustrating an example of a user data database (DB) and a user list DB.

FIG. 15E is a diagram illustrating an example of a user data database (DB) and a user list DB.

### DESCRIPTION OF THE EMBODIMENTS

Exemplary embodiments of the present invention are described below with reference to the drawings. The exemplary embodiments are described below with an MFP as an example of an information processing apparatus. The exemplary embodiments described below do not limit the present invention according to the scope of claims. The present invention does not necessarily require all the combinations of features described in the exemplary embodiments to achieve the object.

### <Description on System Configuration>

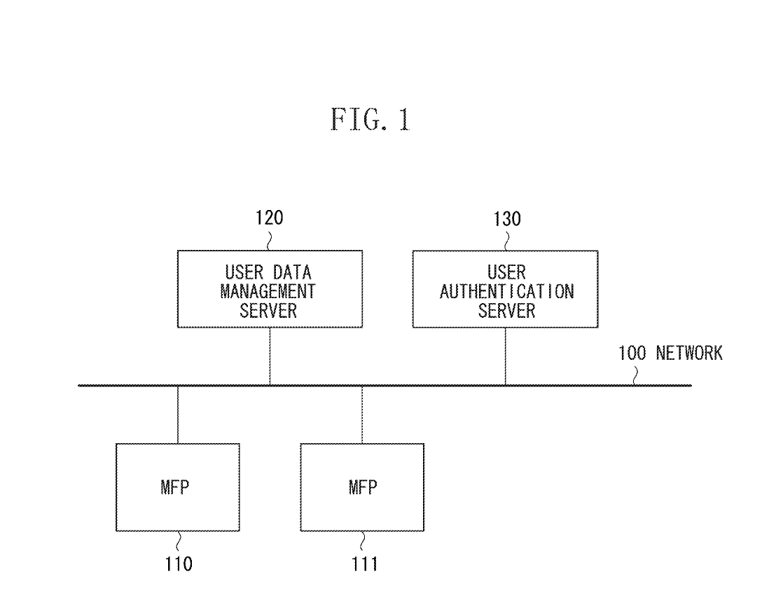

FIG. 1 is a system configuration diagram illustrating a configuration of an information processing apparatus according to a first exemplary embodiment. The MFP that functions as the information processing apparatus in the present exemplary embodiment can execute predetermined job processing. Examples of the executable predetermined job include print job processing, scan job processing, send job processing, facsimile job processing, and the like. The print job processing includes sheet post-processing (such as staple processing and folding processing) in addition to the actual print processing.

In FIG. 1, a user data management server 120, an MFP 110, and a user authentication server 130 that functions as a management apparatus are connected to a network 100. The MFP 110 is an apparatus that implements various types of functions such as copy and FAX for example, and stores therein setting values used for implementing the functions. When the user logs in, the MFP 110 can use the setting for the user.

The user data management server 120 manages user setting values for the MFP 110 and an MFP 111 in an integrated manner. Thus, the user can log in to any MFP and use the same user setting.

The user authentication server 130 is a server for performing user authentication demanded from the MFP 110 or the MFP 111 that has received a login request from a user. Upon receiving the user authentication request, the user authentication server 130 performs the authentication based on user information held by the user authentication server 130, and returns a response to the source of the request. The user authentication server 130 may operate on the same apparatus as the user data management server 120. Alternatively, only the authentication function may be provided in the MFP 110. In the present exemplary embodiment, the MFP 110 is configured to have the user authentication function.

The MFP 110 or 111 to which the user has logged in makes an inquiry to the user data management server 120 through the network 100 to check whether the setting for the logging-in user has changed since the last login time. When the change has been made, a change difference is acquired to perform synchronization. When the user setting has been changed from a state where the user has logged in to any one of the MFPs 110 and 111 previous time, the user data management server 120 is notified of change information through the network 100. The user data management server 120 that has received the change information stores the user setting in a database (DB) therein, and stores the received time point as a latest update time point together with the setting.

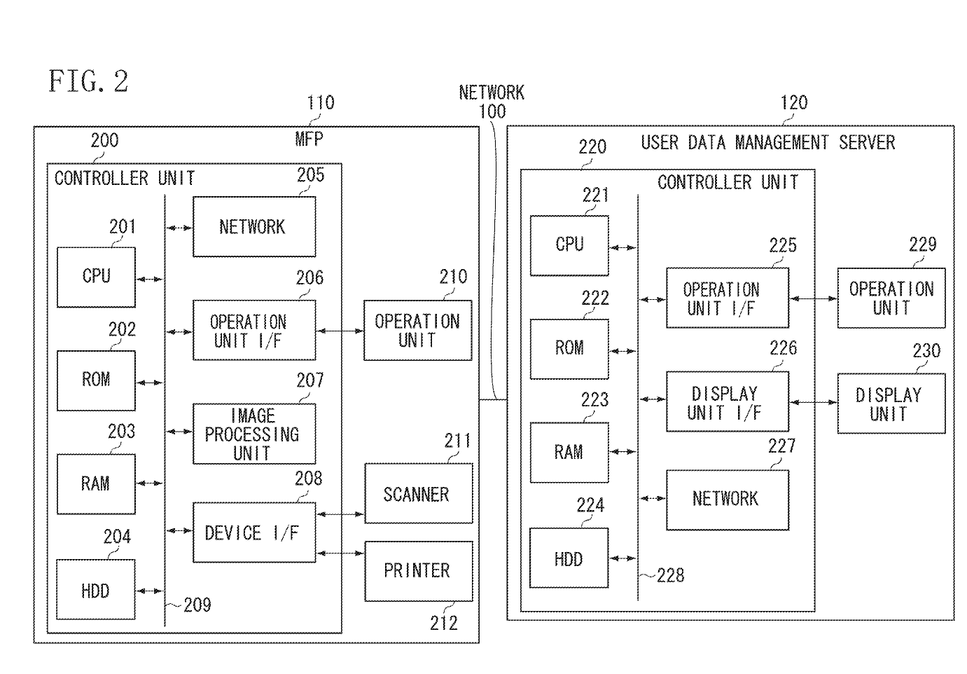

FIG. 2 is a block diagram illustrating configurations of the user data management server 120 and the MFP 110 illustrated in FIG. 1.

In FIG. 2, a controller unit 200 includes a central processing unit (CPU) 201. The CPU 201 starts an operating system (OS) with a boot program stored in a read only memory (ROM) 202. The CPU 201 executes an application program stored in a hard disk drive (HDD) 204 on the OS, and thus executes various types of processing. A random access memory (RAM) 203 is used as a work area for the CPU 201. The RAM 203 provides not only the work area but also an image memory area for temporarily storing image data. The HDD 204 stores the application program, image data, and various setting values. A method of managing a setting value in the MFP 110 is described below.

The ROM 202 and the RAM 203 as well as an operation unit I/F 206, a device I/F 208, Network 205, and an image processing unit 207 are connected to the CPU 201 through a system bus 209. The operation unit I/F 206 is an interface for an operation unit 210 including a touch panel, and outputs image data to be displayed on the operation unit 210, to the operation unit 210. The operation unit I/F 206 transmits information input by a user through the operation unit 210, to the CPU 201. A scanner 211 and a printer 212 are connected to the device I/F 208 that performs synchronous/asynchronous conversion. The Network 205 is connected to the network 100 and inputs and outputs information to and from apparatuses on the network 100 through the network 100. The image processing unit 207 executes processing of an image input from the scanner 211, processing of an output image to the printer 212, image rotation, image compression, resolution conversion, color space conversion, gradation conversion, and the like.

The MFP 110 includes the controller unit 200, the operation unit 210, the scanner 211, and the printer 212. The operation unit 210 is connected to the controller unit 200. In addition, the scanner 211 serving as an image input device, and the printer 212 serving as an image output device are connected to the controller unit 200.

The user data management server 120 includes a controller unit 220, an operation unit 229, and a display unit 230. The controller unit 220 includes a CPU 221. The CPU 221 starts an OS with a boot program stored in a ROM 222.

The CPU 221 executes an application program stored in the HDD 224 on the OS, to execute various types of processing. A RAM 223 is used as a work area for the CPU 221.

The HDD 224 stores the application program and setting values for the MFP 110 such as a virtual device setting. A method of managing the virtual device setting is described in detail below.

The ROM 222 and the RAM 223, as well as an operation unit I/F 225, a display unit I/F 226, and a Network 227 are connected to the CPU 221 through a system bus 228. The operation unit I/F 225 is an interface for an operation unit 229 including a mouse, a keyboard, and the like, and transmits to the CPU 221, information input by the user through the operation unit 229. The display unit I/F 226 outputs image data to be displayed on the display unit 230 including a display and the like, to the display unit 230. The Network 227 is connected to the network 100 and inputs and outputs information to and from each apparatus on the network 100 through the network 100.

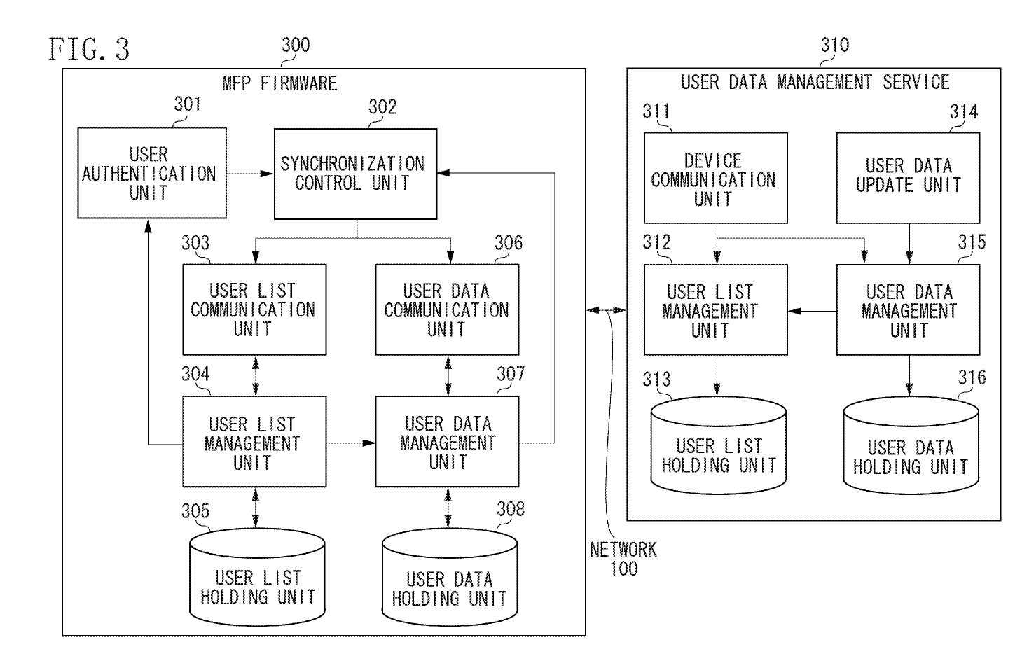

FIG. 3 is a diagram illustrating an example of a software configuration of the information processing system illustrated in FIG. 1. First, each unit of MFP firmware 300 included in the MFP 110 is described.

In FIG. 3, a user authentication unit 301 receives information for identifying a user and an authentication request, and returns an authentication result as a response. For example, an operation unit control unit (not illustrated) causes the operation unit 210 to display a screen for inputting identification information (ID) such as a user name and a password to receive the user name and the password input by the user, and notifies the user authentication unit 301 of the input content.

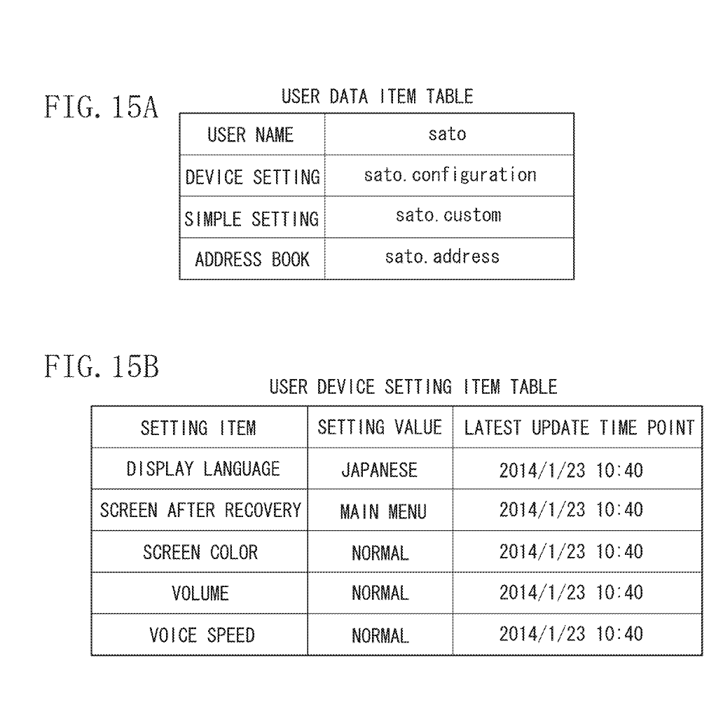

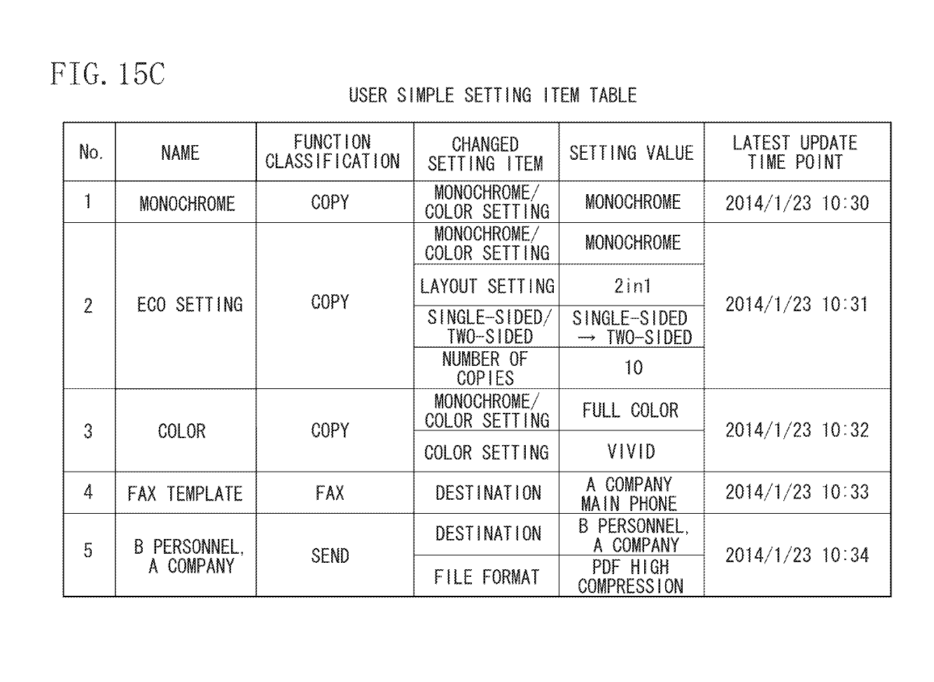

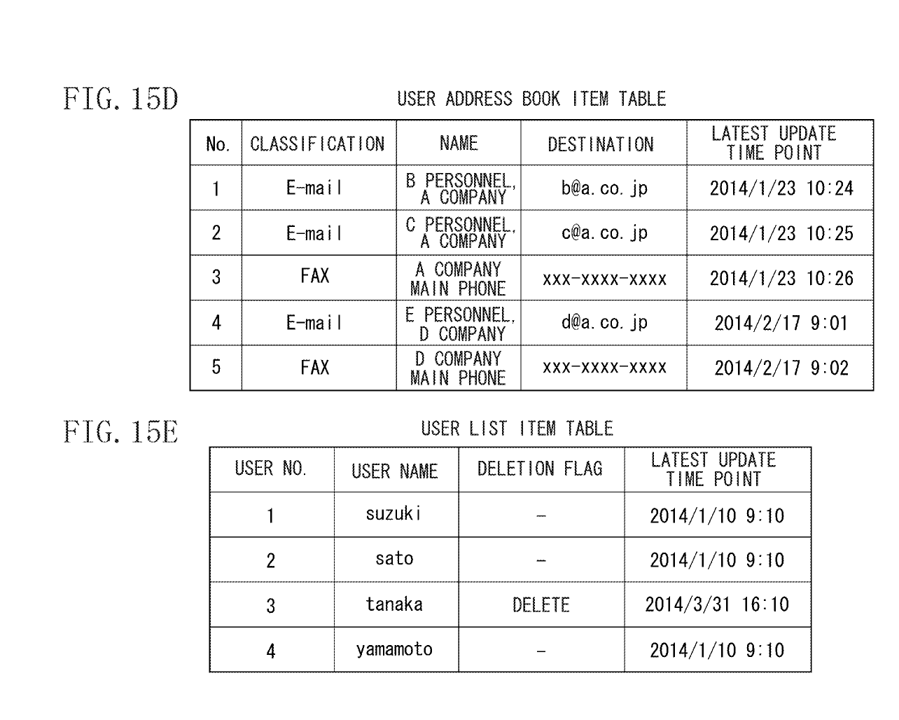

The user authentication unit 301 may perform the authentication by receiving the user name and the password as an authentication request, and matching the authentication request against the authentication information in a main body. The authentication request may alternatively be received by connecting a card reader to the device I/F 208, and acquiring information on an integrated circuit (IC) card with the card reader. The authentication may also be performed as follows. The authentication information is held in the user authentication server 130 and not in the MFP 110, and the authentication result is received from the user authentication server 130 that has been notified of the received authentication request. The MFP 110 transitions to a user login state when the authentication result is successful, and can be used in a setting state dedicated to the user. User data is described in detail below with reference to tables (a) to (e) in FIG. 15.

A synchronization control unit 302 is a unit that controls timing and a synchronization type at which the user data or a user list is synchronized. The synchronization control unit 302 determines each of timing at which the user data is synchronized and timing at which the user list is synchronized, and calls a user list communication unit 303 and a user data communication unit 306. The synchronization type includes update synchronization which notifies the content of change in the MFP 110 to the user data management server 120 for synchronization, and acquisition synchronization which acquires the content of change in the user data management server 120 and reflects in the MFP 110.

The synchronization control unit 302 notifies the user list communication unit 303 and the user data communication unit 306 of any one of the update synchronization and the acquisition synchronization. The synchronization control unit 302 instructs the user data synchronization by acquiring the user information from the user authentication unit 301 and notifying the user data communication unit 306 of the user information.

The timing at which the synchronization control unit 302 calls each of the user list communication unit 303 and the user data communication unit 306 includes once in every predetermined period of time, when the synchronization request is received, or when a device operation (user login/logout, start of the MFP 110, transitioning to sleep, recovering from sleep, and the like) is performed.

For example, when a user logs in to the MFP 110, the synchronization control unit 302 receives a notification indicating that the login has occurred from the user authentication unit 301 and acquires user information. Then, the synchronization control unit 302 requests the user data communication unit 306 to perform acquisition synchronization for the user data of the logging-in user. Alternatively, control is performed in such a manner that the synchronization control unit 302 requests the user list communication unit 303 to perform acquisition synchronization for a user list, and after the acquisition synchronization is completed, the user list acquisition synchronization is requested once in every predetermined time period.

The user list communication unit 303 is a unit by which the information related to the user list is communicated between the MFP 110 and the user data management server 120. The user list communication unit 303 receives a synchronization request related to the user list from the synchronization control unit 302. Upon receiving an acquisition synchronization request, the user list communication unit 303 acquires the latest update time point from a user list management unit 304, and requests the user data management server 120 to transmit the content of the user list changed after the latest update time point. Upon receiving a response from the user data management server 120, the user list communication unit 303 notifies the user list management unit 304 of the content of the response as a user list update notification.

The user list management unit 304 manages the update of a list held by a user list holding unit 305. Upon receiving the user list update notification from the user list communication unit 303, the user list management unit 304 identifies the updated user information. Then, the user list management unit 304 notifies the user list holding unit 305 of the latest update time point included in the user list update notification and the updated user information, so that the user list is updated. When the user list update content is deletion of a user, the user list management unit 304 requests a user data management unit 307 to delete a user data cache with respect to the relevant user.

The user list holding unit 305 holds the user list and the latest update time point of the user list in the HDD 204 serving as a storage unit in the MFP 110 and 111. Upon receiving the user list update instruction, the user list holding unit 305 stores the user list information and the latest update time point in the HDD 204.

The user data communication unit 306 is a unit by which information related to the user data is communicated between the MFP 110 and the user data management server 120. The user data communication unit 306 receives a user list synchronization request from the synchronization control unit 302. When the acquisition synchronization request is received, the user list management unit 304 acquires the latest update time point of the user list from the user list holding unit 305. When the user data cache is present and the latest update time point is successfully acquired, the user list management unit 304 requests the user data management server 120 to transmit the content of the user data updated after the latest update time point.

On the other hand, when the user data cache is not present, the user list management unit 304 performs communications to make a request for all the user data of the user. Then, the user list management unit 304 notifies the user data management unit 307 of the content of the response returned from the user data management server 120 as a user data update notification. When an update synchronization request is received from the synchronization control unit 302, communications are performed to reflect the updated content in a user data management service 310.

The user data management unit 307 manages a user data cache held by a user data holding unit 308. The user data holding unit 308 holds user setting information set for each user. The user setting information corresponds to a unique setting for job processing set by a user through the operation unit 210 of the MFP 110 and 111. More specifically, the user setting information indicates, for example, A3 as the sheet size, 2 in 1 layout, double-sided printing, and 10 copies, for a print job. A plurality of pieces of different user setting information may be held for a same single user.

Upon receiving the user data update request from the user data communication unit 306, the user data management unit 307 requests the user data holding unit 308 to update the user data cache with the update content of user data thus received and the latest update time point. Further, when a request for deleting a user data cache is received from the user list management unit 304, the user data management unit 307 requests the user data holding unit 308 to delete the user data cache of the user corresponding to the request.

The user data holding unit 308 holds the user data cache in the HDD 204 serving as a storage unit in the MFP 110 and 111. Upon receiving an information acquisition request together with information for identifying a user, the user data holding unit 308 transmits user data of the user as a response. Upon receiving an information update request together with the information for identifying a user, the user data holding unit 308 updates the user data cache corresponding to the user and also updates the latest update time point.

Next, a unit of a user data management service 310 provided in the user data management server 120 will be described. A database held by each unit will be described in detail below with reference to the tables (a) to (c) in FIG. 15A and the tables (d) and (e) in FIG. 15B.

The user data management service 310 is a service for providing a function to manage configuration data of the MFP 110, and is provided by the user data management server 120 according to an example described in the present exemplary embodiment. FIG. 2 illustrates a configuration in which the user data management server 120 is connected to the MFP 110. However, the present invention is not limited to this configuration. For example, the user data management service 310 may be provided by the MFP 110, and another MFP 110 may be connected to the MFP 110.

A device communication unit 311 identifies a requested content included in a request received from the MFP 110, and calls the user list management unit 312 or the user data management unit 315. The device communication unit 311 receives response from each management unit for the requested content and transmits the response to the MFP 110 which is the source of the request.

The user list management unit 312 manages a user registered in a user list, and generates a user list in response to a request. Upon receiving a user list acquisition synchronization request from the device communication unit 311, the user list management unit 312 acquires information about the latest update time point when it acquires a synchronization request. Then, the user list management unit 312 requests the user list holding unit 313 to output a user list changed after the latest update time point, and notifies the device communication unit 311 of the output content as a response. Upon receiving information to add or delete a user from the user data management unit 315, the user list management unit 312 instructs the user data holding unit 316 to add the user to the user list or delete the user from the user list.

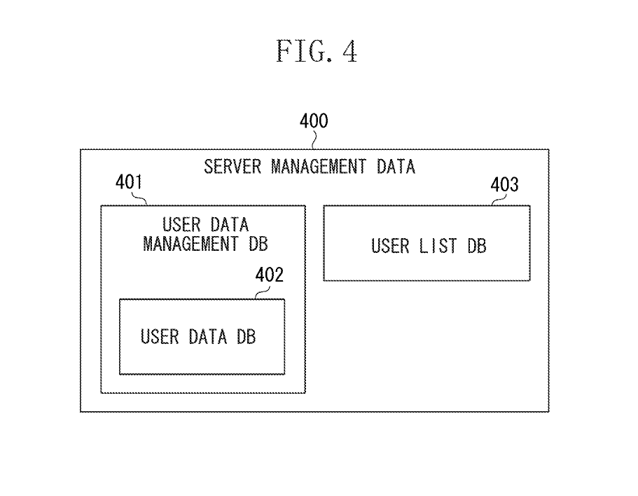

The user list holding unit 313 manages a user list DB 403 in FIG. 4 described below, and updates the user list DB 403 upon receiving the request to add the user to or delete the user from the user list DB 403. The user list holding unit 313 designates the latest update time point, and responds to the request to output the user list changed after the designated latest update time point.

A user data update unit 314 is a unit that receives a deletion request for a user data DB 402 held by the user data management service 310. Upon receiving the request for deleting the user data, the user data update unit 314 requests the user data management unit 315 to delete the user data of the corresponding user.

The user data management unit 315 manages a user data management DB 401 held by the user data holding unit 316. Upon receiving an acquisition request for user information, the user data management unit 315 acquires the user data included in the request, and transmits the user data as a response. Upon receiving an update request for user information, the user data management unit 315 requests the user data holding unit 316 to perform an update in accordance with the received content. When a request for deleting user data is received, the user data management unit 315 requests the user data holding unit 316 to delete the user data, and requests the user list management unit 312 to delete the user from the user list. The designated communication content changed by the user data management unit 315 on the server side is transmitted as a notification.

The user data holding unit 316 holding the user data management DB 401 receives an acquisition/update/delete request in which the user data is designated, and updates the user data DB 402. When the user data DB 402 is updated, the updated content and the latest update time point are stored.

Communications performed by each unit of the firmware described above is carried out between the Network 205 of the MFP 110 and the Network 227 of the user data management server 120 through the network 100.

FIG. 4 is a block diagram illustrating a configuration of data managed by the user data management server 120 according to the present exemplary embodiment.

In FIG. 4, server management data 400 includes the user data management DB 401 and the user list DB 403. The user data management DB 401 includes the user data DB 402 for all the users of all the MFPs connected to the system.

The user data DB 402 includes user data (user setting information) as a dedicated setting for a user. The user data includes a setting value of a device in which a display and an environment are set, a simple setting for reading a setting of operations of copy and FAX functions, and an address book which registers a destination of a FAX and the like.

The user list DB 403 includes user information of all the users of all the MFPs connected to the system. A user who has logged in to the MFP and generated user data is registered in the user list DB 403. When the request for deleting the user data is received, the corresponding user information is not deleted from the user list DB 403 but an attribute indicating that the user data has been deleted is added.

Data stored in the user data DB 402 and the user list DB 403 is described below with reference to the tables in FIGS. 15 A to 15 D. In an example described in the present exemplary embodiment, the user information is identified with a user name. Alternatively, a user ID may be used instead of the name.

The table in FIG. 15A includes user data items in the user data DB 402. The user data DB includes the device setting, the simple setting, and the address book that are identified by a user name and respectively described with reference to the tables in FIGS. 15B to 15D.

The table in FIG. 15B includes user device setting items in the user data DB 402. Items that can be set for each user include a display language, a screen after recovery, a screen color, a volume, and a voice speed. The items are equivalent to the setting items in the device used when no user is logging in, and are items read as the user setting for each user when the user logs in. The latest update time point is recorded as the data and time when the setting value is changed for each setting item.

The table in FIG. 15C includes simple user setting items in the user data DB 402. The simple user setting function is a function of reading a setting of each function of the MFP so that the function becomes immediately available. The simple user setting items include a simple setting name, a function classification such as copy and FAX, setting items to be changed for each function and their setting values, and the latest update time point. For example, in the simple setting No. 2 for a copy function, eco setting is registered as the name, monochrome is registered as a color/monochrome setting, 2 in 1 is registered as a layout setting, single-sided to two-sided is registered as a single-sided/two-sided setting, and 10 is registered as the number of copies. The latest update time point indicates a time point at which the simple setting has been newly generated or last updated.

The table in FIG. 15D includes user address book items included in the user data DB 402. In the address book, the FAX destination and E-mail destination can be registered, and these items can be read when the function is used. The items in the address book include a classification for setting E-mail, FAX, and the like, the address name, an e-mail address or the FAX number as the destination, and the latest update time point.

The table in FIG. 15E includes user list items in the user list DB 403. The user list includes user No., user name, deletion flag, and the latest update time point. When the user data deletion request is received by the user data management server 120, a user list is identified with the corresponding name, and the deletion flag is written.

Processing of synchronizing the user data and the user list executed by the MFP 110 and the user data management server 120 is described below. In the present exemplary embodiment, a flowchart illustrating processing executed by the program of the MFP 110, and a flowchart illustrating processing executed by the user data management server 120 are described. Each step in the flowchart illustrating the processing executed by the program of the MFP 110 is executed when the CPU 201 of the MFP 110 loads the program stored in a memory of the ROM 202 and the like to the RAM 203 to execute the program.

Each step in the flowchart illustrating the processing executed by the program of the user data management server 120 is executed when the CPU 221 of the user data management server 120 loads the program stored in a memory of the ROM 222 and the like to the RAM 223 to execute the program.

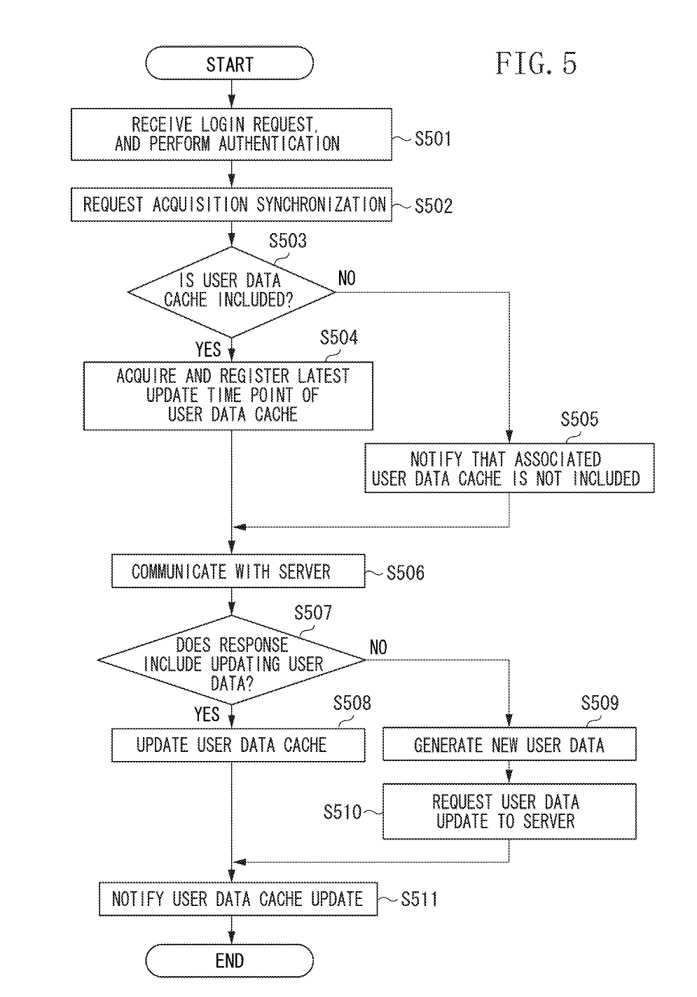

FIG. 5 illustrates a flowchart illustrating a method of controlling the information processing apparatus according to the present exemplary embodiment. Processing according to the present exemplary embodiment starts when the user logs in to the MFP 110 with the login request, the user authentication unit 301 receives the login request, and then the user data is synchronized with the user data management server 120, as described below. The processing in the flowchart starts when the user authentication unit 301 receives the login request. Each step is executed when the CPU 201 illustrated in FIG. 2 executes a stored control program (including the modules illustrated in FIG. 3).

In step S501, the user authentication unit 301 receives a login request from a user. The user authentication unit 301 checks the user information in the login request, and determines whether the authentication is successful. When the authentication is successful, the user authentication unit 301 notifies the synchronization control unit 302 of the successful authentication, and the processing proceeds to S502.

In step S502, the synchronization control unit 302 receives the login request and acquires user information from the user authentication unit 301. Then, the synchronization control unit 302 requests the user data communication unit 306 to perform acquisition synchronization of the user data corresponding to the acquired user information, and the processing proceeds to step S503.

In step S503, the user data communication unit 306 requests the user data management unit 307 to perform the acquisition synchronization. The user data management unit 307 makes an inquiry to the user data holding unit 308 to determine whether a user data cache associated with the received user information is included. When the user data management unit 307 determines that the user data cache is included (Yes in step S503), the processing proceeds to step S504. On the other hand, when the user data management unit 307 determines that the user data cache is not included (No in step S503), the processing proceeds to step S505.

In step S504, the user data management unit 307 acquires the latest update time point of the user data cache acquired in step S503, from the user data holding unit 308. Then, the user data management unit 307 notifies the user data communication unit 306 of the acquired latest update time point, and the processing proceed to step S506.

In step S505, the user data management unit 307 notifies the user data communication unit 306 that the user data cache is not included, and the processing proceeds to step S506.

In step S506, the user data communication unit 306 transmits a user data acquisition request to the user data management server 120. The processing proceeds to step S507 when a response is received from the user data management server 120.

In step S507, the user data communication unit 306 notifies the user data management unit 307 of the response received from the user data management server 120. The user data management unit 307 determines whether the response received from the user data management server 120 includes user data to be updated. When the user data management unit 307 determines that the user data is included (Yes in step S507), the processing proceeds to step S508. When the user data management unit 307 determines that the user data is not included (No in step S507), the processing proceeds to step S509.

In step S508, the user data management unit 307 requests the user data holding unit 308 to update the user data cache with the user data received in step S507. The processing proceeds to step S511 when the cache update is completed by the user data holding unit 308.

In step S509, the user data management unit 307 requests the user data holding unit 308 to generate a user data cache with the received user data, and the processing proceeds to step S510.

In step S510, the user data management unit 307 requests the user data communication unit 306 to update the user data in the user data management server 120 with the new user data generated in step S509. The user data communication unit 306 transmits the request to the user data management server 120 to update the user data with the received new user data. The processing proceeds to step S511 when the response is received from the user data management server 120.

In step S511, the user data management unit 307 notifies the MFP 110 that the user data cache has been updated, and the processing in this flow is terminated.

Thus, control is performed in such a manner that information on the user who has logged in to the information processing apparatus is updated or newly generated, and this user information is synchronized with the user information managed by the management apparatus.

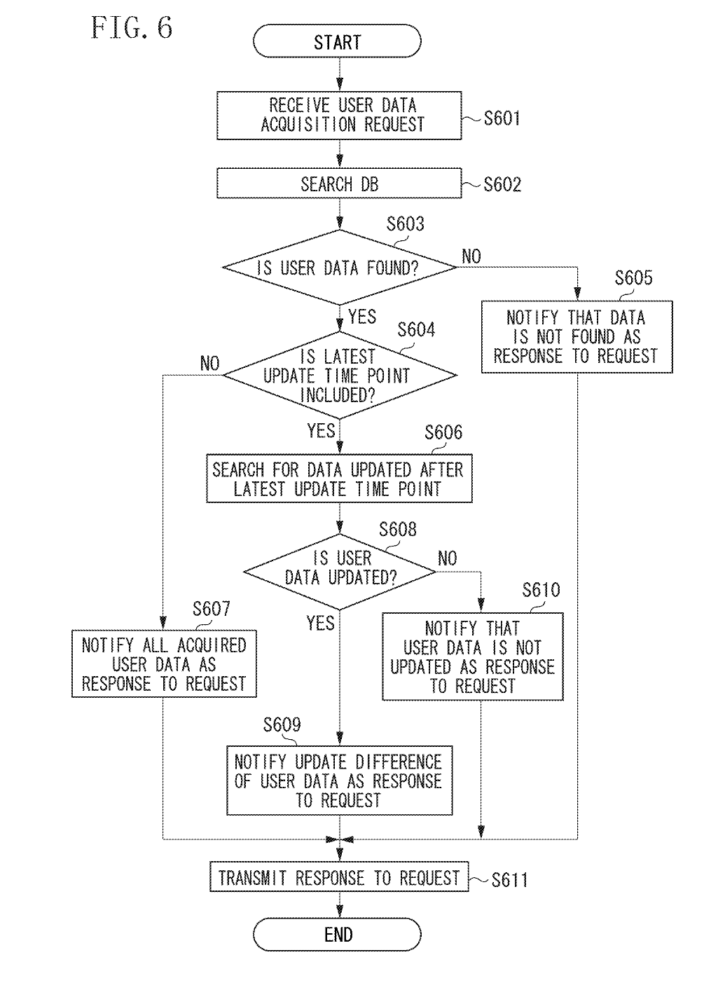

FIG. 6 is a flowchart illustrating a method of controlling a server apparatus according to the present exemplary embodiment. This processing example starts when the user data management server 120 receives a user data acquisition request from the MFP 110 and is terminated when user data of the corresponding user is transmitted to the MFP 110. Each step is implemented when the CPU 221 illustrated in FIG. 2 executes a stored control program (including the module illustrated in FIG. 3).

In step S601, the device communication unit 311 receives a user data acquisition request from the user data communication unit 306 of the MFP 110, and notifies the user data management unit 315 of the user data acquisition request, and the processing proceeds to step S602.

In step S602, the user data management unit 315 acquires user information from the received user data acquisition request, and requests the user data holding unit 316 to search for the corresponding user data, and the processing proceeds to step S603.

In step S603, the user data management unit 315 checks the result of the search by the user data holding unit 316. When the user data management unit 315 determines that the user data is found (Yes in step S603), the processing proceeds to step S604. On the other hand, when the user data management unit 315 determines that the user data is not found (No in step S603), the processing proceeds to step S605.

In step S604, the user data management unit 315 determines whether the received user data acquisition request includes the latest update time point. When the user data management unit 315 determines that the latest update time point is recorded (Yes in step S604), the processing proceeds to step S606. On the other hand, when the user data management unit 315 determines that the latest update time point is not included (No in step S604), the processing proceeds to step S607.

In step S605, the user data management unit 315 notifies the device communication unit 311 that the user data is not found as a response to the user data acquisition request, and the processing proceeds to step S611.

In step S606, the user data management unit 315 requests the user data holding unit 316 to search for updated data based on the user information and the latest update time point included in the user data acquisition request received from the MFP 110, and the processing proceeds to step S608.

In step S607, the user data management unit 315 requests the user data holding unit 316 to acquire all user data that can be identified from the user information in the user data acquisition request. Then, the user data management unit 315 notifies the device communication unit 311 of all the acquired user data as a response to the user data acquisition request, and the processing proceeds to step S611.

In step S608, the user data management unit 315 checks a result of the search requested to the user data holding unit 316 in step S606 to determine whether any data is updated after the latest update time point. If the user data management unit 315 determines that the data is updated (Yes in step S608), the processing proceeds to step S609. On the other hand, when the user data management unit 315 determines that no data has been updated (No in step S608), the processing proceeds to step S610.

In step S609, the user data management unit 315 requests the user data holding unit 316 to acquire an update difference of the user data updated after the latest update time point, from the user information and the latest update time point included in the user data acquisition request. Then, the user data management unit 315 notifies the device communication unit 311 of the acquired user data update difference as a response to the user data acquisition request, and the processing proceeds to step S611.

In step S610, the user data management unit 315 notifies the device communication unit 311 that no user data has been updated after the latest update time point, and processing proceeds to step S611.

In step S611, the device communication unit 311 transmits the response from the user data management unit 315 to the user data communication unit 306 of the MFP 110, and the processing in this flow is terminated.

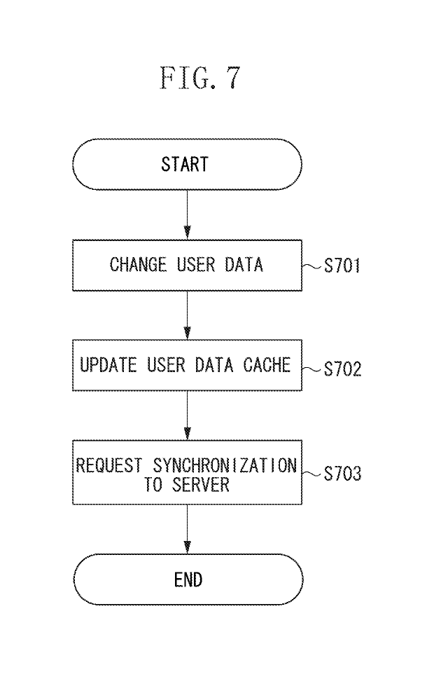

FIG. 7 is a flowchart illustrating a method of controlling the information processing apparatus according to the present exemplary embodiment. In this processing example, when user data is changed in the MFP 110, the changed content is synchronized with data in the user data management server 120. The processing starts in a state where a user is logging in to the MFP 110. Each step is implemented when the CPU 201 illustrated in FIG. 2 executes a stored control program (including a module illustrated in FIG. 3).

In step S701, an operation control unit (not illustrated) that controls the operation unit 210 receives a change in the user data. Then, the operation control unit requests the user data management unit 307 to update the user data, and the processing proceeds to step S702.

In step S702, the user data management unit 307 identifies the update content from the user data update request received in step S701. Then, the user data management unit 307 requests the user data holding unit 308 to update the user data cache identified by the information about a logging-in user from which an operation has been received.

The user data holding unit 308 updates the user data cache, and notifies the user data management unit 307 of the update result, and the processing proceeds to step S703.

In step S703, the user data management unit 307 requests the synchronization control unit 302 to perform the update synchronization so that the content of the user data update request received in step S701 is synchronized with the user data in the user data management service 310. The synchronization control unit 302 notifies the user data communication unit 306 of the received update synchronization request, and the user data communication unit 306 transmits the user data update request to the user data management service 310. The processing in this flowchart is terminated when a response to the updating synchronization request is received from the user data management service 310.

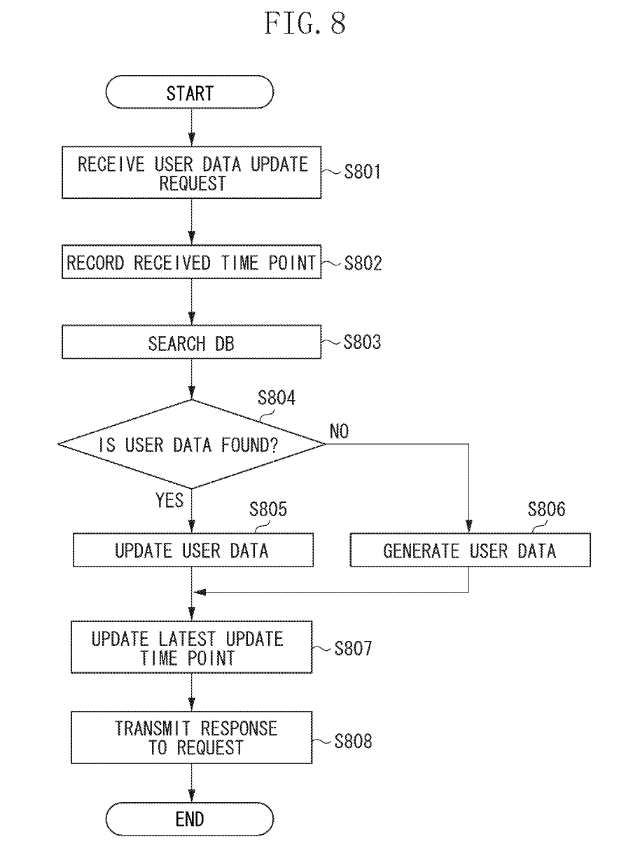

FIG. 8 is a flowchart illustrating a method of controlling the server apparatus according to the present exemplary embodiment. This processing example starts when the user data management server 120 receives the user data update request from the MFP 110, and is terminated when a response to the request is transmitted. Each step is implemented when the CPU 221 illustrated in FIG. 2 executes a stored control program (including the module illustrated in FIG. 3).

In step S801, the device communication unit 311 receives the user data update request from the user data communication unit 306 of the MFP 110. Then, the device communication unit 311 notifies the user data management unit 315 of the user data update request, and the processing proceeds to step S802.

In step S802, the user data management unit 315 records a time point at which the user data update request has been received, and the processing proceeds to step S803.

In step S803, the user data management unit 315 acquires user information from the received user data update request. Then, the user data management unit 315 requests the user data holding unit 316 to search for the corresponding user data, and the processing proceeds to step S804.

In step S804, the user data management unit 315 determines whether the user data is found. When the user data management unit 315 determines that there is the corresponding user data (S804 YES), the processing proceeds to step S805. On the other hand, when the user data management unit 315 determines that there is no corresponding user data (S804 NO), the processing proceeds to step S806.

In step S805, the user data management unit 315 requests the user data holding unit 316 to update the user data in accordance with the user data update request received in step S801. The user data holding unit 316 identifies the user data DB 402 to be updated from the user information in the received user data update request, and updates the user data. Then, the user data management unit 315 updates the latest update time point of the user data DB 402 using the reception time recorded in step S802, and the processing proceeds to step S807.

In step S806, the user data management unit 315 newly generates user data with the user data update request received in step S801. Then, the user data management unit 315 requests the user data holding unit 316 to register the generated user data. The user data holding unit 316 registers the received new user data in the user data DB 402, and records the reception time recorded in step S802 as the latest update time point, and the processing proceeds to step S807.

In step S807, the user data management unit 315 updates the latest update time point of the user data DB 402 using the reception time recorded in step S802, and the processing proceeds to step S808. In step S808, the device communication unit 311 transmits the response from the user data management unit 315 to the user data communication unit 306 of the MFP 110, and the processing in this flowchart is terminated.

Thus, control is performed in such a manner that the user data managed by the management apparatus is updated in accordance with the user data update request received from the information processing apparatus.

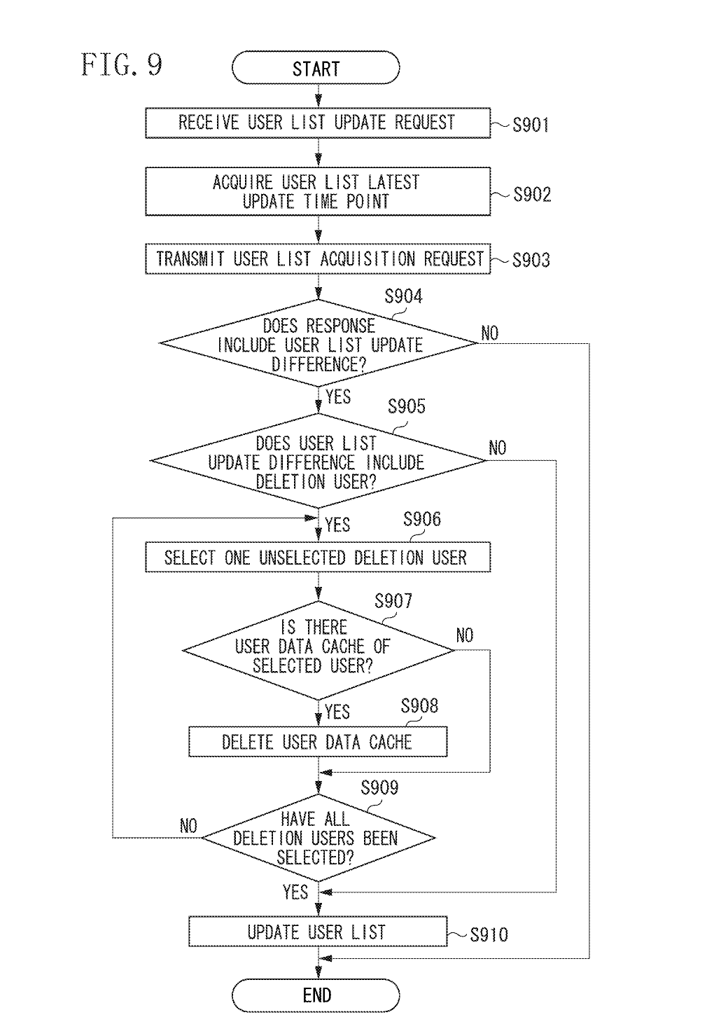

FIG. 9 is a flowchart illustrating a method of controlling the information processing apparatus according to the present exemplary embodiment. This processing example starts when the MHP 110 receives a user list update request, and is terminated when the user list is updated. Each step is implemented when the CPU 201 illustrated in FIG. 2 executes a stored control program (including the module illustrated in FIG. 3).

In step S901, the MFP 110 receives the user list update request. Then, the synchronization control unit 302 determines that the acquisition synchronization timing for the user list has arrived, and requests the user list communication unit 303 to perform the user list acquisition synchronization, and the processing proceeds to step S902.

In step S902, the user list communication unit 303 requests the user list management unit 304 to transmit the user list latest update time point. The processing proceeds to step S903, when the user list latest update time point is acquired.

In step S903, the user list communication unit 303 transmits the user list acquisition request to the user data management server 120. Then, the processing proceeds to step S904 when a response is received from the user data management server 120.

In step S904, the user list communication unit 303 determines whether list update information as the response received from the user data management server 120 includes a difference. When the user list communication unit 303 determines that the list update information includes the difference (Yes in step S904), the processing proceeds to step S905. On the other hand, when the user list communication unit 303 determines that the list update information includes no difference (No in step S904), the processing in this flowchart is terminated.

In step S905, the user list communication unit 303 determines whether the difference in the list update information includes information about a user deleted from the list. When the user list communication unit 303 determines that the list update information includes such information (Yes in step S905), the processing proceeds to step S906. On the other hand, when the user list communication unit 303 determines that the list update information does not include such information (No in step S905), the processing proceeds to step S910.

In step S906, the user list communication unit 303 notifies the user list management unit 304 of the list update information. The user list management unit 304 selects one of unselected deletion users from the received list update information, and the processing proceeds to step S907.

In step S907, the user list management unit 304 makes an inquiry to the user data management unit 307 to check whether there is a user data cache of the user selected in step S906. The user data management unit 307 requests the user data holding unit 308 to check whether a user data cache of the selected user is stored, and notifies the user list management unit 304 of the check result. When the user list management unit 304 determines that the user data cache is stored (Yes in step S907), the processing proceeds to step S908. On the other hand, when the user list management unit 304 determines that the user data cache is not stored (No in step S907), the processing proceeds to step S909.

In step S908, the user list management unit 304 requests the user data management unit 307 to delete the user data cache of the user selected in step S906. The user data management unit 307 requests the user data holding unit 308 to delete the user data cache of the selected user, and the processing proceeds to step S909 when the user data management unit 307 determines that the deletion processing has been successfully executed.

In step S909, the user list management unit 304 determines whether all the deletion users in the list update information have been selected. When the user list management unit 304 determines that all the deletion users have been selected (Yes in step S909), the processing proceeds to step S910. When the user list management unit 304 determines that there is still an unselected user (No in step S909), the processing returns to step S906.

In step S910, the user list management unit 304 updates the user list with the list update information received in step S906. The user list is updated by notifying the user list holding unit 305 of additional user information and deletion user information in the list update information. The processing in this flowchart is terminated when the user list is updated.

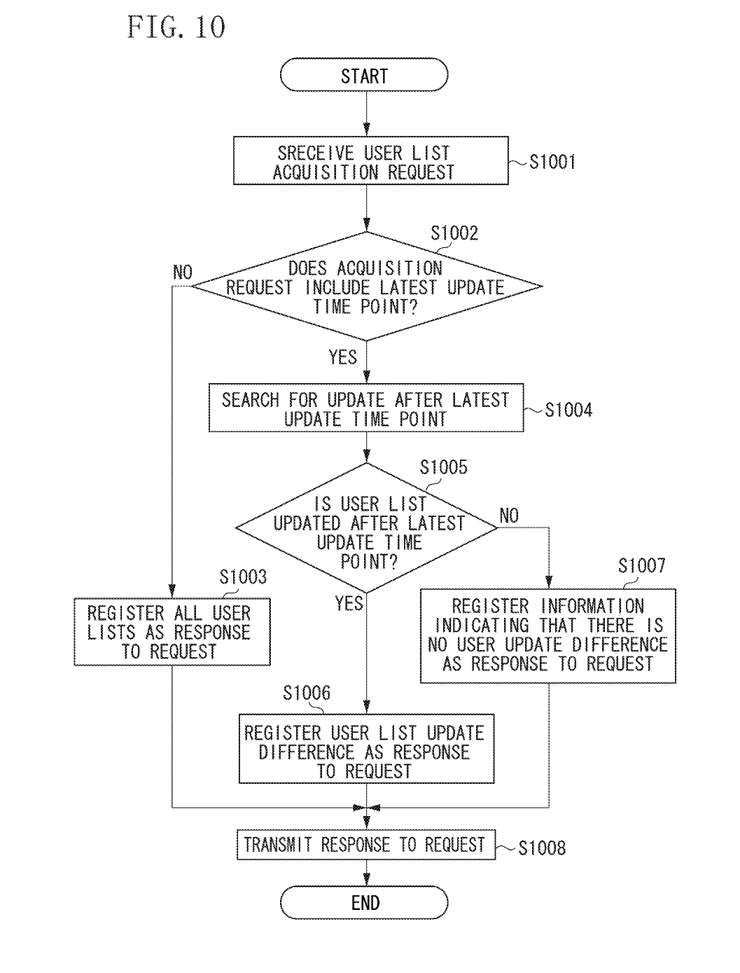

FIG. 10 is a flowchart illustrating a method of controlling the server apparatus according to the present exemplary embodiment. This processing example starts when the user data management server 120 receives a user list acquisition update request from the MFP 110, and is terminated when a response to the request is transmitted. Each step is implemented when the CPU 221 illustrated in FIG. 2 executes a stored control program (including the module illustrated in FIG. 3).

In step S1001, the device communication unit 311 receives the user list acquisition request from the MFP 110. The device communication unit 311 notifies the user list management unit 312 of the request received from the MFP 110, and the processing proceeds to step S1002.

In step S1002, the user list management unit 312 determines whether the user list acquisition request received from the MFP 110 includes the latest update time point. When the user list management unit 312 determines that the latest update time point is included (Yes in step S1002), the processing proceeds to step S1004. On the other hand, when the user list management unit 312 determines that the latest update time point is not included (No in step S1002), the processing proceeds to step S1003.

In step S1003, the user list management unit 312 asks the user list holding unit 313 for the lists of all the users held by the list holding unit 313. The user list holding unit 313 generates the user list including a user for which a deletion flag is set and a user for which a deletion flag is not set in the user list DB 403 respectively defined as a deleted user and a utilizing user.

The user list management unit 312 registers the user list including the utilizing user and the deleted user thus generated in a response to the user list acquisition request, and the processing proceeds to step S1008.

In step S1004, the user list management unit 312 requests the user list holding unit 313 to search for the user list update difference updated after the received latest update time point, and the processing proceeds to step S1005.

In step S1005, the user list management unit 312 determines whether there is the user list update difference requested in step S1004. When the user list management unit 312 determines that there is the user list update difference (Yes in step S1005), the processing proceeds to step S1006. On the other hand, when the user list management unit 312 determines that there is no user list update difference (No in step S1005), the processing proceeds to step S1007.

In step S1006, the user list management unit 312 notifies the user list holding unit 313 of the latest update time point included in the request received in step S1001. The user list holding unit 313 identifies an item that has been updated after the latest update time point from the information registered in the user list DB 403, and generates the user list in which the user for which the deletion flag is set is defined as the deleted user and a user for which the deletion flag is not set is defined as the utilizing user. Then, the user list management unit 312 registers the user list including the utilizing user and the deleted user thus generated as well as the acquired user list update difference in a response to the user list acquisition request, and the processing proceeds to step S1008.

In step S1007, the user list management unit 312 registers information indicating that there is not the user list update difference, in the response to the user list acquisition request, and the processing proceeds to step S1008.

In step S1008, the user list management unit 312 notifies the device communication unit 311 of the response to the user list acquisition request. The device communication unit 311 transmits the response thus received to the user list communication unit 303 of the MFP 110, and the processing in this flowchart is terminated.

FIG. 11 is a flowchart illustrating a method of controlling the server apparatus according to the present exemplary embodiment. This proceeding example starts when the user data management server 120 receives a user data edit request, and is terminated when the user data management DB 401 and the user list DB 403 are updated. Each step is implemented when the CPU 221 illustrated in FIG. 2 executes a stored control program (including the module illustrated in FIG. 3).

In step S1101, the user data update unit 314 receives the user data edit request. In the present exemplary embodiment, a deletion instruction is described as the content of editing. When the content of the editing of the user list is confirmed, the user data update unit 314 notifies the user data management unit 315 of the editing request, and the processing proceeds to step S1102.

In step S1102, the user data management unit 315 determines whether the received editing request is a user data deletion request. When the user data management unit 315 determines that the received editing request is the user data deletion request (Yes in step S1102), the processing proceeds to step S1103. On the other hand, when the user data management unit 315 determines that the received editing request is a request other than the user data deletion request (No in step S1102), the processing proceeds to step S1105.

In step S1103, the user data management unit 315 determines whether user data is stored as a target of the deletion request received in step S1101. When the user data management unit 315 determines that the target user data is stored (Yes in step S1103), the processing proceeds to step S1104. On the other hand, when the user data management unit 315 determines that there is no target user data (No in step S1103), the processing proceeds to step S1105.

In step S1104, the user data management unit 315 instructs the user data holding unit 316 to delete the user data of the user which is the target of the deletion request received in step S1101. The user data holding unit 316 deletes the user data DB 402 as the target of the received request, and the processing proceeds to step S1105.

In step S1105, the user data management unit 315 requests the user list management unit 312 to update the user list in accordance with the edit request received in step S1101. The user list management unit 312 notifies the user list holding unit 313 of the received user list update request. The user list holding unit 313 updates the user list DB 403 in accordance with the received user list update request. The update request is the user data deletion request in the present case, and the deletion flag is set to the designated user data and updated. The processing in the flowchart is terminated when the user list DB 403 is updated.

As described above, in the present exemplary embodiment, the user data can be deleted by the user data management server 120 without performing the user operation on each of the MFPs 110 and 111. Thus, the user data to be deleted from the MFP used by the user can be prevented from being forgotten and continuing to remain.

The second exemplary embodiment will be described as follows. In the first exemplary embodiment, the example is described where the user data is deleted through synchronization of the user data and the user list between the MFP 110 and the user data management server 120.

However, the operation of deleting the user data in the user data management server 120 needs to be performed by an administrator and not by the user him or herself. When the administrator deletes the user data, the corresponding user might happen to be logging in to the MFP 110. In such a case, if the MFP 110 with the synchronized user list deletes the user data cache, the user is unable to properly operate the MFP 110. Thus, in this second exemplary embodiment, control processing is described that is performed to determine whether to delete a user data cache when the user list is synchronized while a user is logging in. In the present exemplary embodiment, only a portion related to the present exemplary embodiment is described, and a description on a portion that is the same as that in the first exemplary embodiment is omitted.

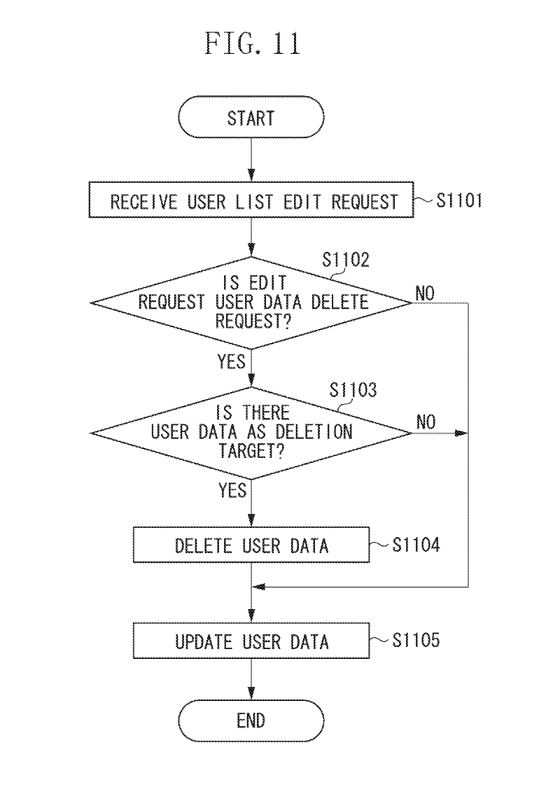

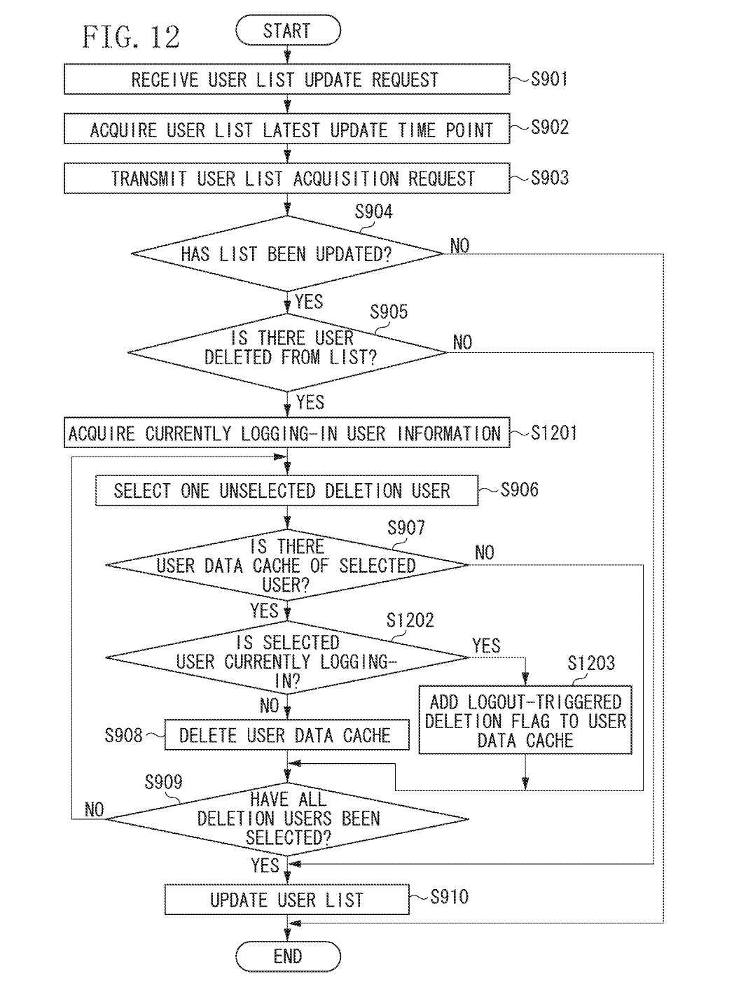

FIG. 12 is a flowchart illustrating a method of controlling the information processing apparatus according to the present exemplary embodiment. This processing example starts when the MFP 110 receives the user list update request, and is terminated when the user list is updated, and the user data is deleted or a logout-triggered deletion flag is set. Only processing different from that in FIG. 9 is described with respect to this flowchart, and the description on the same processing is omitted. Each step is implemented when the CPU 201 illustrated in FIG. 2 executes a stored control program (including the module illustrated in FIG. 3).

Processing in steps S901 to S905 is the same as that in FIG. 9 corresponding to the first exemplary embodiment. When the user list communication unit 303 determines that there is information about a user to be deleted in S905, the processing proceeds to step S1201. On the other hand, when the user list communication unit 303 determines that there is no information about a user to be deleted in S905, the processing proceeds to step S910.

In step S1201, the user list management unit 304 acquires information about a currently logging-in user from the user authentication unit 301, and temporarily stores the information, and the processing proceeds to step S906. Processing in steps S906 and S907 is the same as that in FIG. 9 corresponding to the first exemplary embodiment.

In step S907, the user list management unit 304 makes an inquiry to the user data management unit 307 to check whether a user data cache of the user selected in step S906 is stored. When the user list management unit 304 determines that the user data cache is stored (Yes in step S907), the processing proceeds to step S1202. On the other hand, when the user list management unit 304 determines that the user data cache is not stored (No in step S907), the processing proceeds to step S909.

In step S1202, the user list management unit 304 reads the information about the currently logging-in user stored in step S1201, and determines whether the information includes the user selected in step S906. When the user list management unit 304 determines that the user is included (Yes in step S1202), the processing proceeds to step S1203. On the other hand, when the user list management unit 304 determines that the user is not included (No in step S1202), the processing proceeds to step S908.

In step S1203, the user list management unit 304 sets the deletion flag to the user data cache as the deletion target, and the processing proceeds to step S909. Processing from step S908 to step S910 is the same as that in FIG. 9 corresponding to the first exemplary embodiment.

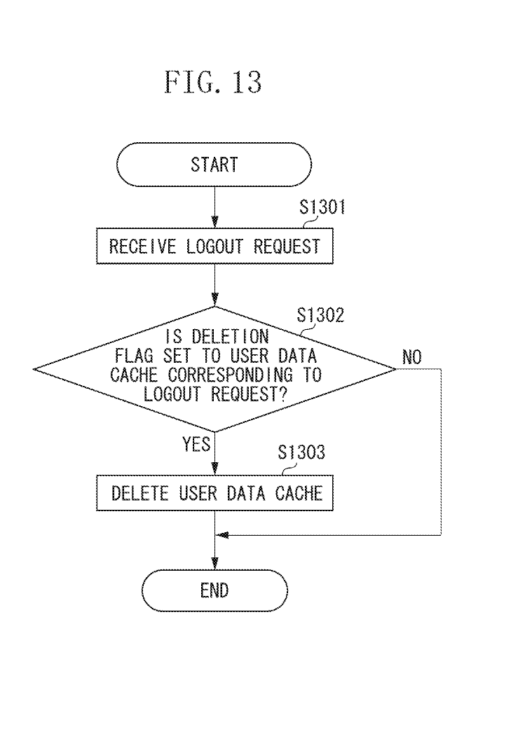

FIG. 13 is a flowchart illustrating a method of controlling the information processing apparatus according to the present exemplary embodiment. This processing example starts when the MFP 110 to which a user has logged in receives a logout request and is terminated when a user data cache deletion determination is made. Each step is implemented when the CPU 201 illustrated in FIG. 2 executes a stored control program (including the module illustrated in FIG. 3).

In step S1301, the user authentication unit 301 receives the logout request from the user, and notifies the synchronization control unit 302 of the logout request and the user information, and the processing proceeds to step S1302.

In step S1302, the synchronization control unit 302 receives the logout request, and notifies the user data communication unit 306 of the logout request. The user data communication unit 306 notifies the user data management unit 307 of the user information and requests the user data management unit 307 to check the user data cache deletion flag. The user data management unit 307 requests the user data holding unit 308 to determine whether the deletion flag is set to the user data cache corresponding to the received user information. When the user data holding unit 308 determines that the deletion flag is set (Yes in step S1302), the processing proceeds to step S1303. When the user data holding unit 308 determines the deletion flag is not set (No in step S1302), the processing in this flowchart is terminated.

In step S1303, the user data management unit 307 instructs the user data holding unit 308 to delete the user data cache, and the user data holding unit 308 deletes the user data cache, and the processing in this flowchart is terminated.

Thus, the present exemplary embodiment describes a solution to the problem that occurs when the user data management server 120 receives the user data deletion instruction, and the user list is synchronized by the MFP 110 while the user that uses the deletion target data is logging in.

With the method described in the present exemplary embodiment, the user data cache is not deleted while the user is logging in to the MFP 110 and is deleted at the time of log-out. Accordingly, the user data can be deleted after the operation of the user using the user data is properly terminated.

The third exemplary embodiment will be described as follows. In the first and the second exemplary embodiments, the user authentication unit 301 of the MFP 110 performs the user authentication. The user information needs to be managed and the user authentication may be controlled by using the user authentication server 130 when the number of users increases. In the system configuration illustrated in FIG. 1 using the user authentication server 130, the user information and the user data are managed separately. Thus, when a user stops using the system, the administrator has to go through a cumbersome procedure of deleting the user information from the user authentication server 130 and deleting the user data from the user data management server 120.

Thus, in this third exemplary embodiment, control is performed to delete the user data held by the user data management server 120 in conjunction with the deletion of the user information from the user authentication server 130. In the present exemplary embodiment, only portions related to the present exemplary embodiment are described, and a description on the portions that are the same as those in the first and the second exemplary embodiments are omitted.

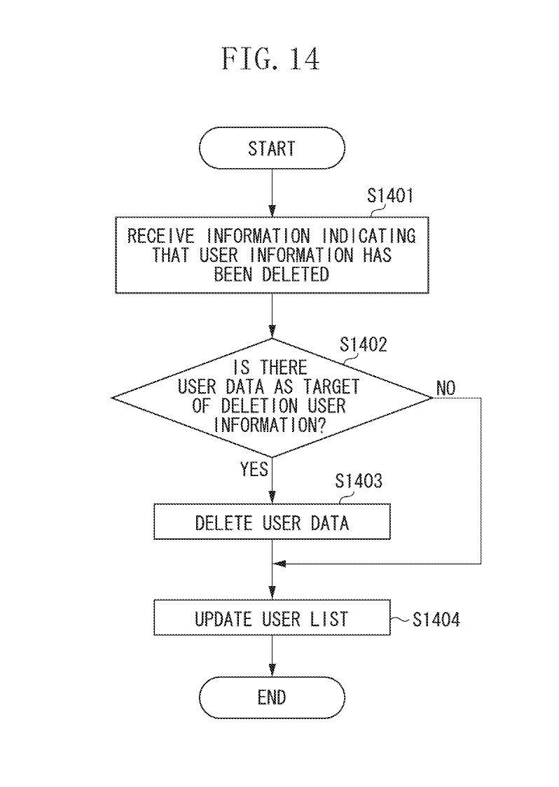

FIG. 14 is a flowchart illustrating a method of controlling the server apparatus according to the present exemplary embodiment. This processing example starts when the user data management server 120 detects that the user information has been deleted in the user authentication server 130, and is terminated when the user data is deleted. Each step is implemented when the CPU 221 illustrated in FIG. 2 executes a stored control program (including the module illustrated in FIG. 3).

In step S1401, the user data management unit 315 receives information indicating that the user information is deleted from the user authentication server 130 through the network 100, and the processing proceeds to step S1402.

In step S1402, the user data management unit 315 determines whether the user data corresponding to the user information received in step S1401 is stored. When the user data management unit 315 determines that the user data is stored (Yes in step S1402), the processing proceeds to step S1403. On the other hand, when the user data management unit 315 determines that the user data is not stored (No in step S1402), the processing proceeds to step S1404.

In step S1403, the user data management unit 315 instructs the user data holding unit 316 to delete the user data corresponding to the user information received in step S1401. The user data holding unit 308 deletes the corresponding user data DB 402, and the processing proceeds to step S1404.

In step S1404, the user data management unit 315 notifies the user list management unit 312 of the delete target user information received in step S1401. The user list management unit 312 instructs the user list holding unit 313 to update the deletion flag in the user list DB 403 corresponding to the received delete target user information. The user list holding unit 313 updates the user list DB 403 by setting the deletion flag to the user corresponding to the received user information, and the processing in this flowchart is terminated.

In the present exemplary embodiment, when the user authentication information is managed by the user authentication server 130, the user data in the user data management server 120 can be deleted by deleting the target user information which is managed for the authentication.

Thus, only the user authentication server 130 needs to manage the user while preventing deletion of the user data from being forgotten, so that the user data does not remain.

In the exemplary embodiments described above, a user dedicated setting is deleted by the user data management server designating the user, so that the user dedicated setting can be deleted from all the image forming apparatuses connected to the user data management server. Thus, a problem that a user dedicated setting remains against the will of the user can be solved only through an operation on the user data management server.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-244868, filed Dec. 3, 2014, which is hereby incorporated by reference herein in its entirety.

What is claimed is:

1. An information processing apparatus configured to execute job processing, the information processing apparatus comprising:
a communication unit configured to communicate with a management apparatus for managing the information processing apparatus;
a management unit configured to register and manage authenticated user information and setting information associated with the authenticated user in a storage unit;
a request unit configured to request, using the communication unit, a holding unit managed by the management apparatus, to register the user information and the setting information associated with the user managed by the management unit;
an acquisition unit configured to acquire from the management apparatus, update information indicating an updated content of a user list for which the management apparatus manages the setting information; and
a control unit configured to synchronize the user information registered in the storage unit with the user information managed by the management apparatus, based on an update time point in the acquired update information.

2. The information processing apparatus according to claim 1,
wherein the acquisition unit is configured to acquire the setting information of the user from the management apparatus; and
wherein the control unit is configured to synchronize the setting information of the user registered in the storage unit with the setting information of the user managed by the management apparatus, based on the update time point included in the acquired update information.

3. The information processing apparatus according to claim 1, further comprising a first identification unit configured to identify user information to be deleted out of the user information registered in the storage unit, based on the update time point included in the acquired update information,
wherein the control unit is configured to delete the setting information of the user associated with the identified user information, from the storage unit, and synchronizing the user information and the setting information of the user managed by the management apparatus.

4. The information processing apparatus according to claim 3, further comprising a second identification unit configured to identify user information to be updated out of the user information registered in the storage unit, based on the update time point included in the acquired update information,
wherein the control unit is configured to update the setting information of the user associated with the identified user information, and synchronize the user information and the setting information of the user managed by the management apparatus.

5. The information processing apparatus according to claim 3, further comprising a determination unit configured to determine whether the user is currently logging in, before setting information of a user associated with the identified user information is deleted from the storage unit,
wherein when the determination unit determines that the user is currently logging in, the control unit is configured to delete the setting information of the user associated with the identified user information from the storage unit after the user logs out, and synchronize the user information and the setting information of the user managed by the management apparatus.

6. A management apparatus configured to communicate with a plurality of information processing apparatuses for executing job processing, the management apparatus comprising:
a management unit configured to register, in a holding unit, user information acquired from each of the information processing apparatuses and setting information of a user associated with the user information and manage the user information and the setting information of the user;
a first update unit configured to update a list of registered users, based on the user information acquired from each of the information processing apparatuses;
a second update unit configured to update setting information of a user associated with the list of the registered users, based on the user information acquired from each of the information processing apparatuses;
a first response unit configured to transmit update information about the list of registered users that has been updated in response to a request to update the user information from each of the information processing apparatuses, to the information processing apparatus as a source of the update request; and
a second response unit configured to transmit update information of updated setting information associated with user in response to a request to update the setting information of the user from each of the information processing apparatuses, to the information processing apparatus as a source of the update request.

7. The management apparatus according to claim 6, wherein the management apparatus is configured to communicate with an authentication server for authenticating a user logging in to any of the information processing apparatuses.

8. The management apparatus according to claim 7, further comprising a control unit configured to delete setting information of a user associated with deleted user information based on user information acquired from the authentication server, and update the user information and the setting information of the user.

9. A method of controlling an information processing apparatus configured to execute job processing, the method comprising:
communicating by using a communication unit, with a management apparatus configured to manage the information processing apparatus;
registering authenticated user information and setting information associated with the authenticated user in a storage unit, and managing the user information and the setting information associated with the user;
requesting by using the communication unit, registration of the user information and the setting information associated with the user that are managed in the managing, in a holding unit managed by the management apparatus;
performing first acquisition of acquiring, from the management apparatus, update information indicating a content of update of a user list for which the management apparatus manages the setting information; and
performing first control of synchronizing the user information registered in the storage unit with the user information managed by the management apparatus, based on an update time point included in the acquired update information.

10. The method of managing the information processing apparatus according to claim 9, further comprising:
performing second acquisition of setting information of a user from the management apparatus; and
performing second control of synchronizing the setting information of the user registered in the storage unit with the setting information of the user managed by the management apparatus, based on the update time point included in the acquired update information.

11. The method of managing the information processing apparatus according to claim 9, further comprising:
performing first identification of identifying user information to be deleted, out of the user information stored in the storage unit, based on the updated time point included in the acquired update information; and
performing third control of deleting setting information of a user associated with the identified user information from the storage unit, and synchronizing the user information and the setting information of the user that are managed in the managing.

12. A method of controlling a management apparatus configured to communicate with a plurality of information processing apparatuses for executing job processing, the method comprising:
registering user information acquired from each of the information processing apparatuses and setting information of a user associated with the user information, in a holding unit, and managing the user information and the setting information of the user;
performing first update of updating a list of the registered user, based on the user information acquired from each of the information processing apparatuses;
performing second update of updating the setting information of the user associated with the list of the registered user, based on the user information acquired from each of the information processing apparatuses;
performing first response of transmitting update information of the updated user list in response to a request to update the user information from each of the information processing apparatuses, to the information processing apparatus as a source of the update request; and
performing second response of transmitting update information of the updated setting information of the user in response to a request to update the setting information of the user from each of the information processing apparatuses, to the information processing apparatus as a source of the update request.

13. A non-transitory computer readable storage medium that stores a program for causing a computer to implement job processing to execute:
registering authenticated user information and setting information of the user in a storage unit, and managing the user information and the setting information of the user;
requesting by using a communication unit, registration of the user information and the setting information of the user that are managed by a managing unit, in a holding unit managed by a management apparatus;
performing first acquisition of acquiring from the management apparatus, update information indicating a content of update of a user list for which the management apparatus manages the setting information; and
performing first control of synchronizing the user information registered in the storage unit with the user information managed by the management apparatus, based on an update time point in the acquired update information.

14. A non-transitory computer readable storage medium that stores a program for causing a computer to communicate with a plurality of information processing apparatuses to execute:
registering user information acquired from each of the information processing apparatuses and setting information of a user associated with the user information, in a holding unit, and managing the user information and the setting information of the user;
performing first update of updating a list of the registered user, based on the user information acquired from each of the information processing apparatuses;
performing second update of updating the setting information of the user associated with the list of the registered user, based on the user information acquired from each of the information processing apparatuses;
performing first response of transmitting update information of the updated user list in response to a request to update the user information from each of the information processing apparatuses, to the information processing apparatus as a source of the update request; and
performing second response of transmitting update information of the updated setting information of the user in response to the request to update the setting information of the user from each of the information processing apparatuses, to the information processing apparatus as a source of the update request.
